(19) United States
(12) Patent Application Publication
(10) Pub. No.: US 2025/0308781 A1
(43) Pub. Date: Oct. 2, 2025

(54) MULTILAYER CERAMIC ELECTRONIC DEVICE AND DIELECTRIC CERAMIC COMPOSITION

(71) Applicant: TAIYO YUDEN CO., LTD., Tokyo (JP)

(72) Inventor: Koichiro MORITA, Takasaki-shi (JP)

(21) Appl. No.: 19/061,817

(22) Filed: Feb. 24, 2025

(30) Foreign Application Priority Data
Mar. 29, 2024 (JP) 2024-056801
Aug. 7, 2024 (JP) 2024-130967

(51) Int. Cl. H01G 4/12

(52) U.S. Cl. CPC H01G 4/1218

(57) ABSTRACT

A multilayer ceramic electronic device includes a dielectric layer that contains a plurality of crystal grains, internal electrodes that sandwich the dielectric layer and contain nickel or copper as a main component, and an external electrode that is electrically connected to one of the internal electrodes. Each of the plurality of crystal grains has a core portion and a shell portion surrounding the core portion. A main component of the core portion and the shell portion is barium titanate. Calcium is solid-dissolved in the shell portion. A concentration of calcium of the shell portion is 10 times or more than a concentration of calcium of the core portion.

### CROSS-REFERENCE TO RELATED APPLICATION

This application is based upon and claims the benefit of priority of the prior Japanese Patent Application No. 2024-056801, filed on Mar. 29, 2024, and Japanese Patent Application No. 2024-130967, filed on Aug. 7, 2024, the entire contents of which are incorporated herein by reference.

### FIELD

A certain aspect of the present disclosure relates to a multilayer ceramic electronic device and a dielectric ceramic composition.

### BACKGROUND

In high-frequency communication systems such as mobile phones, multilayer ceramic electronic components such as multilayer ceramic capacitors (MLCCs) are used to eliminate noise (for example, see Japanese Patent Application Publication No. 2002-226263 hereinafter referred to as Document 1, Japanese Patent Application Publication No. 2002-284571 hereinafter referred to as Document 2, Japanese Patent Application Publication No. 2009-161417 hereinafter referred to as Document 3, Japanese Patent Application Publication No. 2007-001859 hereinafter referred to as Document 4, Japanese Patent Application Publication No. 2017-028225 hereinafter referred to as Document 5, Japanese Patent Application Publication No. 2013-180906 hereinafter referred to as Document 6, Japanese Patent Application Publication No. 2016-128372 hereinafter referred to as Document 7, Japanese Patent Application Publication No. 2017-014093 hereinafter referred to as Document 8, Japanese Patent Application Publication No. 2006-151766 hereinafter referred to as Document 9, and Japanese Patent Application Publication No. 2013-209239 hereinafter referred to as Document 10).

### SUMMARY OF THE INVENTION

According to an aspect of the embodiments, there is provided a multilayer ceramic electronic device including: a dielectric layer that contains a plurality of crystal grains, each of which has a core portion and a shell portion surrounding the core portion, a main component of the core portion and the shell portion being barium titanate, calcium being solid-dissolved in the shell portion, a concentration of calcium of the shell portion being 10 times or more than a concentration of calcium of the core portion; internal electrodes that sandwich the dielectric layer and contain nickel or copper as a main component; and an external electrode that is electrically connected to one of the internal electrodes.

According to another aspect of the embodiments, there is provided a dielectric ceramic composition including: a plurality of crystal grains, each of which has a core portion and a shell portion surrounding the core portion, wherein a main component of the core portion and the shell portion is barium titanate, wherein calcium is solid-dissolved in the shell portion, and wherein a concentration of calcium of the shell portion is 10 times or more than a concentration of calcium of the core portion.

### BRIEF DESCRIPTION OF THE DRAWINGS

FIG. 1 is a schematic cross-sectional view illustrating a dielectric ceramic composition according to a first embodiment;

FIG. 2 illustrates bias characteristics;

FIG. 3A illustrates a case 1;

FIG. 3B illustrates a case 2;

FIG. 4 illustrates a grain boundary or a grain boundary triple point;

FIG. 5 illustrates a perspective view of a multilayer ceramic capacitor, in which a cross section of a part of the multilayer ceramic capacitor is illustrated;

FIG. 6 is a cross-sectional view taken along line A-A in FIG. 5;

FIG. 7 is a cross-sectional view taken along line B-B in FIG. 5;

FIG. 8A and FIG. 8B illustrates an enlarged view of an XZ cross section;

FIG. 9 illustrates a manufacturing method of a multilayer ceramic capacitor;

FIG. 10A and FIG. 10B illustrate a forming process of an internal electrode;

FIG. 11 illustrates a crimping process;

FIG. 12 illustrates an element map of Example 1-1;

FIG. 13 illustrates an element map of Comparative Example 1-1; and

FIG. 14 illustrates an element map by TEM-EDX analysis of Example 2.

### DETAILED DESCRIPTION

Multilayer ceramic electronic devices are broadly divided into Class I, which uses paraelectrics as the dielectric material, and Class II, which uses ferroelectrics. Class II multilayer ceramic electronic devices are also called high dielectric constant types, and use materials with a high relative dielectric constant of several thousand or more, such as barium titanate (BaTiO₃). This makes it possible to achieve very high capacity density (electrostatic capacity per unit volume), and small, large-capacity multilayer ceramic electronic devices have become common. On the other hand, Class II multilayer ceramic electronic devices have the disadvantage that they are unsuitable for high-voltage applications because they are ferroelectrics and therefore have the characteristic (DC bias characteristic) that when a direct current voltage (DC bias) is applied, the electrostatic capacity decreases according to the magnitude of the voltage (DC bias).

In recent years, there has been a demand for multilayer ceramic electronic devices with high rated voltage and high capacity for in-vehicle applications, so improving the bias characteristic has become important. In order to improve the bias characteristics of Class II multilayer ceramic electronic devices, various methods of material modification have been proposed. The main method is to use a compound in which some elements are replaced during the synthesis of barium titanate to change the barium titanate into a ferroelectric different from the barium titanate as the main phase instead of the barium titanate. Examples include Ba(Ti,Zr)O₃ (see Document 1, for example), in which part of the titanium is replaced with zirconium, and (Ba,Ca,Sr)TiO₃ (see Document 2, for example), in which part of the barium is replaced with calcium and strontium. Information on similar methods, such as BaZrO₃ (see Document 3, for example), has also been made public. Another method has been reported in which barium titanate is made to contain trace amounts of transition elements and alkaline earth elements (see Documents 4 and 5, for example). A method has also been proposed in which a material corresponding to Class II, which has physical properties completely different from barium titanate in terms of its crystal structure, is used. For example, there are materials with a tungsten bronze structure (see, for example, Document 6). There are also many reports of materials using bismuth or lead that have excellent bias characteristics (see, for example, Documents 7 and 8).

However, the element-substituted barium titanate materials (for example, Documents 1 to 5) are methods for making the bias characteristics moderate by significantly reducing the ferroelectricity of barium titanate. This makes it possible to keep the rate of change in the relative dielectric constant with respect to the bias small, but there is a problem that the absolute value of the relative dielectric constant, which is the key, becomes too low. Materials with a crystal structure other than barium titanate (see, for example, Document 6) have a relative dielectric constant before the application of bias that is significantly lower than that of barium titanate, so even if the rate of change in the relative dielectric constant is small, the absolute value of the relative dielectric constant is small. Materials containing bismuth or lead (for example, Documents 7 and 8) have variations in absolute value of relative dielectric constant depending on the material composition, so they are promising materials for bias characteristics, but they have a problem that they cannot be fired simultaneously with base metal electrodes such as nickel (the materials are reduced in the dielectric). Bismuth-based materials are not suitable for mass production because the range of optimal oxygen partial pressure conditions is too narrow. Furthermore, bismuth and lead have high vapor pressures, and they evaporate during firing, especially in a reducing atmosphere, causing large changes in sinterability and electrical properties, so there is a problem that the characteristic variations between individuals become unacceptably large.

Hereinafter, an exemplary embodiment will be described with reference to the accompanying drawings.

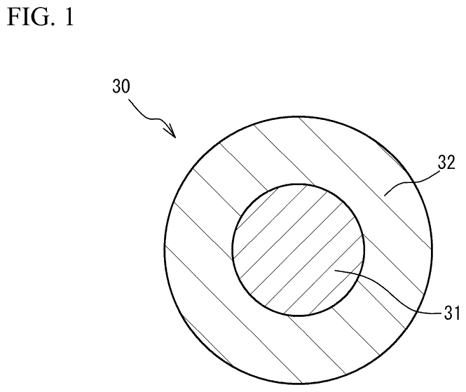

(First Embodiment) FIG. 1 is a schematic cross-sectional view illustrating a dielectric ceramic composition according to a first embodiment. As illustrated in FIG. 1, the dielectric ceramic composition includes a crystal grain 30 having a core-shell structure. The crystal grain 30 having the core-shell structure has a core portion 31 having a substantially spherical shape and a shell portion 32 surrounding and covering the core portion 31. The core portion 31 is a crystal portion in which an additive compound is not solid-dissolved or in which the amount of the additive compound solid-dissolved is small. The shell portion 32 is a crystal portion in which the additive compound is solid-dissolved and has a higher additive compound concentration than the additive compound concentration in the core portion 31. The additive compound concentration in the shell portion 32 is higher than the additive compound concentration in the core portion 31. Alternatively, the additive compound is diffused in the shell portion 32, and the additive compound is not diffused in the core portion 31.

In this embodiment, a main component of the crystal grain 30 is barium titanate. For example, the crystal grain 30 contains 90 at % or more of barium titanate. The shell portion 32 contains calcium as a solid solution. The calcium concentration in the shell portion 32 is 10 times or more that in the core portion 31.

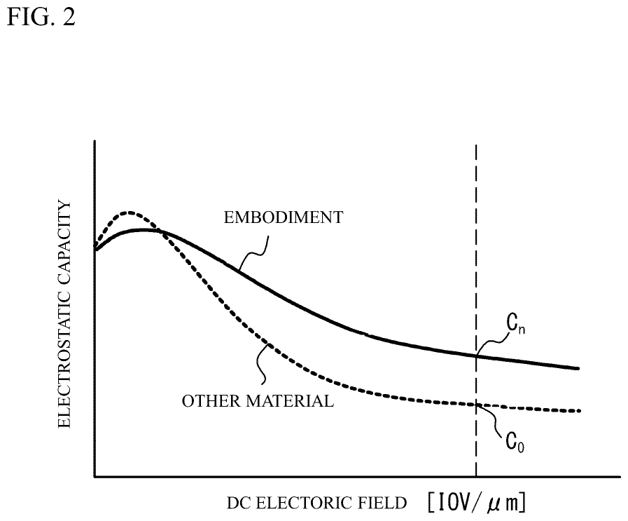

This configuration allows the bias characteristics to be improved without excessively lowering the relative dielectric constant of the dielectric ceramic composition, so that a high relative dielectric constant can be achieved in a high electric field. In other words, the bias characteristics can be improved while maintaining ferroelectricity. For example, as illustrated in FIG. 2, in other materials (materials with normal barium titanate as the main phase or normal core-shell structure), the electrostatic capacity decreases as the applied voltage increases, but in the dielectric ceramic composition according to this embodiment, the decrease in electrostatic capacity can be suppressed even when the applied voltage increases. For example, a high absolute value of the relative dielectric constant (for example, 930@10V/μm) that cannot be obtained with other materials at 10V/μm or more is possible. Furthermore, at 10 V/μm, when the electrostatic capacity of the dielectric ceramic composition according to this embodiment is Cn and the electrostatic capacity of the other material is C₀, Cn/C₀≥1.5. No problems occur even if an internal electrode made of a base metal is used.

In addition, by simultaneously solid-dissolving a rare earth element such as holmium in the shell portion 32, it is possible to extend the material life. In addition, since there is a high degree of freedom in the grain boundary composition, it is possible to further improve the life without deteriorating the bias characteristics (grain characteristics) by placing aluminum, magnesium, or manganese in addition to silicon at the grain boundaries.

Due to the above characteristics, it is possible to design a multilayer ceramic electronic device having a base metal internal electrode that is optimal for applications that require high reliability in addition to a high effective capacity under high voltages such as in-vehicle applications.

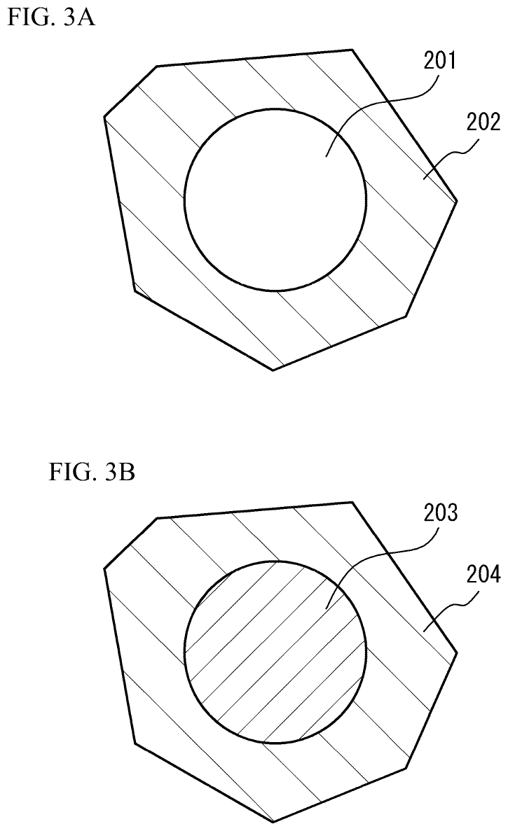

Here, the difference between the dielectric ceramic composition according to this embodiment and other materials will be explained. First, the other materials will be classified into Case 1 and Case 2. The crystal grain in FIG. 3A is case 1, and has a core portion 201 of barium titanate, but has a shell portion 202 in which calcium is not solid-dissolved. Typically, the main component of the additive to the shell portion 202 is magnesium. The crystal grain in FIG. 3B is case 2, and has a core-shell structure resulting from the solid solution of rare earth elements in a core portion 203 mainly made of (Ba, Ca)TiO₃.

First, the problem of case 1 will be explained. In case 1, when the core portion 201 is made of barium titanate and the shell portion 202 is composed of low-valence cations such as Mg²⁺ or Mn²⁺ that substitute for the Ti⁴⁺site, the shell portion 202 becomes an acceptor-type shell with respect to Ti⁴⁺, and an oxide ion vacancy is generated due to the electrically neutral condition. The oxide ion vacancy can pin polarization, deteriorating the bias characteristics, or cause insulation deterioration by migration under an electric field. Conversely, if the shell portion 202 is composed of high-value cations such as V⁵⁺ or Nb⁵⁺ that substitute for the Ti⁴⁺ site, the shell portion 202 becomes a donor type. In this case, oxide ion vacancy is not generated, but the insulating property is reduced due to the excess electron injected. Therefore, a design is usually made to maintain a balance of characteristics by arranging acceptor-type and donor-type cations in the shell in a balanced manner.

In regard to this point, in the dielectric ceramic composition according to this embodiment, Ca²⁺, which is an additive element to the shell portion 32, is a cation that substitutes the Ba²⁺ site with the same valence, and therefore does not become an acceptor or a donor. In addition, since the ionic radius of Ca²⁺ is smaller than that of Ba²⁺, the volume of the crystal lattice having the perovskite structure of BaTiO₃ is contracted by calcium being solid-dissolved. This strengthens the bond between the oxide ion and the cation, and has the effect of suppressing the electric field migration of oxide ion vacancy. In other words, it is possible to achieve a high level of balance between the bias characteristics, insulation properties, and reliability.

Next, the problem of Case 2 will be explained. Since the original grain is not barium titanate but (Ba, Ca)TiO₃, the core portion 203 becomes (Ba, Ca)TiO₃, and when a rare earth element or the like is solid-dissolved from outside the grain, a shell portion 204 containing calcium is formed. However, because the core portion 203 is (Ba, Ca)TiO₃, it requires more energy for polarization reversal than BaTiO₃, and therefore the relative dielectric constant is low to begin with, and only multilayer ceramic electronic device with a smaller capacity can be designed compared to the present embodiment, which has a BaTiO₃ core with a high dielectric constant. Structurally, case 2 is completely different from the dielectric ceramic composition of the present embodiment. In a structure with a (Ba, Ca)TiO₃ core, the calcium concentration of the core and the shell is essentially almost the same, and the core and the shell are not separated by the calcium concentration.

Also, Document 9 discloses a structure in which CaZrO₃ (or CaO and ZrO₂) are added to BaTiO₃ to have a region in which calcium is diffused from the outside to the inside of BaTiO₃. In this document, in order to keep the temperature characteristics within X8R, it is a necessary condition that the thickness of the calcium diffusion region is within the range of 10% to 30% of the grain diameter D50% grain diameter. This document also claims that the “DC bias characteristic” is improved, but the phenomenon described in this document with the term “DC bias characteristic” refers to “change in relative dielectric constant over time under a DC electric field”, and is a different characteristic from the Bias characteristic described in this specification, “the phenomenon in which the relative dielectric constant decreases due to the application of an external DC electric field (nonlinear dielectric constant characteristic)”. The former “change in relative dielectric constant over time under a DC electric field” is generally called “DC aging characteristic” or “DC bias aging characteristic”. What is improved in this embodiment is not “aging” but the “static characteristic” DC Bias characteristic, and the effect of the target is completely different from that of the document. In addition, this embodiment is also different in that the thickness of the shell portion 32 is not limited, and it is preferable that the thickness has a distribution. In addition, this document states that the rare earth element includes “at least one selected from Sc, Er, Tm, Yb, and Lu”, but these rare earth elements are not a necessary condition for the dielectric ceramic composition according to this embodiment. In Document 10, Ca is listed as one of the candidate shell constituent elements, with the requirement that Tb and Yb are included (the example shows only Mg shell), but like Document 9, it is designed to ensure the temperature characteristics of X8R and is not intended to improve the bias characteristics. In particular, Tb and Yb do not provide the bias improvement effect of the dielectric ceramic composition of this embodiment.

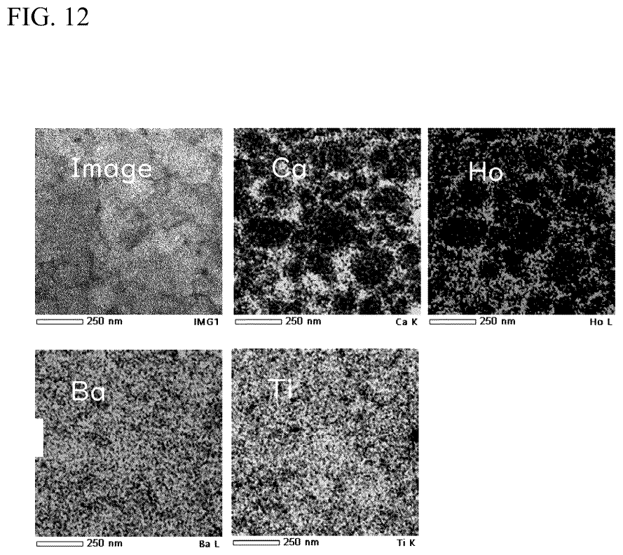

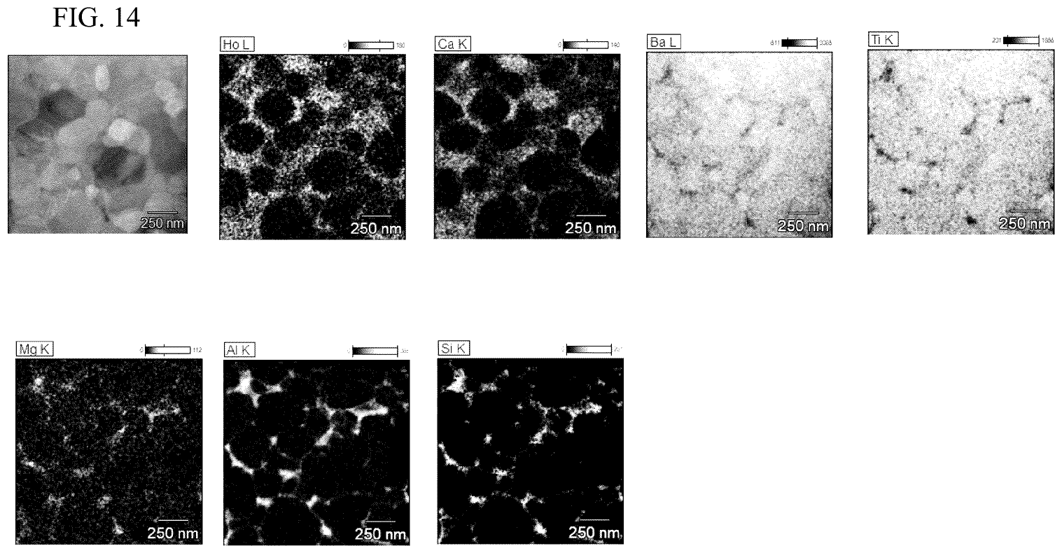

The calcium concentration in the core portion 31 and the calcium concentration in the shell portion 32 can be measured by the following method. First, elemental mapping of calcium is performed using a transmission electron microscope (TEM) equipped with an Energy Dispersive X-ray Spectroscopy (EDX) detector. With this structure, a clear contrast is obtained between the core portion 31 in the center of the grain, where almost no calcium is detected, and the shell portion 32, where a large amount of calcium is detected (for example, FIG. 12 and FIG. 14). The center of each of the regions of the core portion 31 and the shell portion 32 thus distinguished is quantitatively analyzed by EDX to determine the calcium concentration in each region. This is performed for 10 grains, and the average calcium concentration in each of the regions of the core portion 31 and the shell portion 32 is calculated. If the average calcium concentration in the shell portion 32 is 10 times or more that of the core portion 31, it is determined that this structure is present.

The calcium concentration in the shell portion 32 is preferably 20 times or more that of the core portion 31, and more preferably 40 times or more.

In the crystal grain 30, the amount of calcium is preferably 1.0 mol or more and 5.0 mol or less, more preferably 1.6 mol or more and 4.5 mol or less, and even more preferably 2.0 mol or more and 4.0 mol or less, with respect to 100 mol of barium titanate.

From the viewpoint of extending the material life, the shell portion 32 of the dielectric ceramic composition according to this embodiment preferably contains a rare earth element. For example, the shell portion 32 preferably contains at least one of gadolinium, dysprosium, holmium, or yttrium. In the shell portion 32, the amount of these rare earth elements is preferably, for example, 0.5 mol % or more and 2.0 mol % or less, more preferably 0.8 mol % or more and 1.5 mol % or less, and even more preferably 1.0 mol % or more and 1.2 mol % or less, with respect to 100 mol of barium titanate.

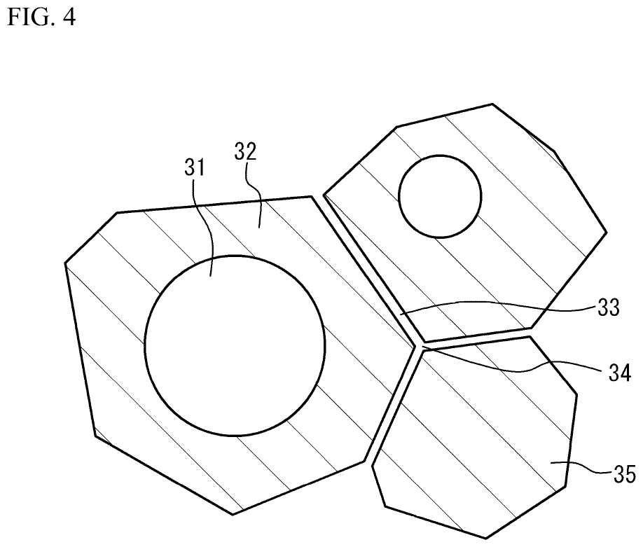

To ensure reliability, it is preferable that an additive element is present at the grain boundary of the crystal grain 30. For example, as illustrated in FIG. 4, it is preferable that silicon is present at a grain boundary 33 or a grain boundary triple point 34 between the crystal grain 30 and other crystal grains. Furthermore, it is preferable that at least one of aluminum, magnesium, or manganese is present at the grain boundary 33 or the grain boundary triple point 34. The grain boundary 33 is the boundary between two crystal grains. The grain boundary triple point 34 is the boundary between three or more crystal grains.

In the dielectric ceramic composition according to this embodiment, the amount of silicon is preferably 0.5 mol or more and 3.0 mol or less per 100 mol of barium titanate. The total amount of grain boundary components other than silicon (one or more of aluminum, magnesium, or manganese) is preferably 1.0 mol or more and 5.0 mol or less, more preferably 1.5 mol or more and 4.0 mol or less, and even more preferably 2.0 mol or more and 3.0 mol or less.

From the viewpoint of maintaining the core-shell structure, it is preferable to set a lower limit on the average grain size of the crystal grains. In this embodiment, when the plurality of crystal grains 30 are sintered together in the dielectric ceramic composition, the average grain size of the plurality of crystal grains 30 is preferably 50 nm or more, more preferably 80 nm or more, and even more preferably 100 nm or more.

On the other hand, from the viewpoint of ensuring sinterability, it is preferable to set an upper limit on the average grain size of the crystal grains. In this embodiment, when the plurality of crystal grains 30 are sintered together in the dielectric ceramic composition, the average grain size of the plurality of crystal grains 30 is preferably 400 nm or less, more preferably 300 nm or less, and even more preferably 250 nm or less.

The average grain size of the crystal grains 30 in the dielectric ceramic composition can be measured by the following method. First, the cross section is photographed with a SEM (scanning electron microscope), and the maximum distance from the electrode surface to each grain in the horizontal direction is measured. This is performed for 100 grains, and the average value is calculated.

Furthermore, it is preferable that the dielectric ceramic composition according to this embodiment contains a sub-crystal grain having a different structure from the crystal grain 30. For example, as illustrated in FIG. 4, it is preferable that the dielectric ceramic composition according to this embodiment contains a sub-crystal grain 35. The sub-crystal grain 35 has a structure different from that of the crystal grain 30 in that, when calcium element mapping is performed by TEM-EDX, the core portion 31, which is a region where calcium is almost absent, is not confirmed, and the sub-crystal grains 35 have a smaller grain size than the average grain size.

In addition, when the dielectric ceramic composition according to this embodiment has a structure in which the plurality of crystal grains 30 are sintered, it is preferable that the width of the shell portion 32 in each crystal grain 30 is distributed. For example, it is preferable that the width of the shell portion 32 is large in some of the crystal grains 30 and small in other crystal grains 30. In this case, since the electric field strength required to reverse the polarization of the crystal grains 30 is distributed, the electrostatic capacity decreases more gradually with respect to an increase in Bias. Therefore, it becomes possible to design a high relative dielectric constant in a wide electric field region. For example, in the plurality of crystal grains 30, the difference between the minimum width and the maximum width of each shell portion 32 is preferably 10 nm or more, more preferably 20 nm or more, and even more preferably 30 nm or more. The width of the shell portion 32 is obtained by observing the cross section with a TEM and performing a line analysis of calcium concentration and silicon concentration from the core center to the grain boundary so as to pass through the center of the grain. The electron beam is scanned from the center of the core portion 31 toward the grain boundary, and the point where the calcium concentration at the core center is 10 times higher is defined as the boundary between the core portion 31 and the shell portion 32. The electron beam is then scanned from the shell portion 32 toward the grain boundary, and the point where the silicon concentration is detected to be 10 times or higher than in the shell portion 32 is defined as the boundary between the shell portion 32 and the grain boundary. Here, since silicon is an element that is not solid-dissolved in the main phase, the actual silicon concentration distribution is usually detected at the grain boundary in the shell portion 32 below the detection limit. The distance (including the boundary point) between the core portion/shell portion boundary and the shell portion/grain boundary interface thus determined is defined as the width of the shell portion 32.

In addition, from the viewpoint of further improving the bias characteristics, it is preferable that the crystal grains according to this embodiment contain strontium in the shell portion 32.

In addition, by adding strontium so that the atomic concentration ratio of strontium to the sum of strontium and calcium is 0.2 or more, the bias characteristics are significantly improved. However, as the amount of strontium added increases, there is a side effect that the capacity-temperature characteristics deteriorate. Therefore, it is preferable that the atomic concentration ratio of strontium to the sum of strontium and calcium is 0.4 or less. In this case, the capacity-temperature characteristics can be made to comply with EIA standard X7T.

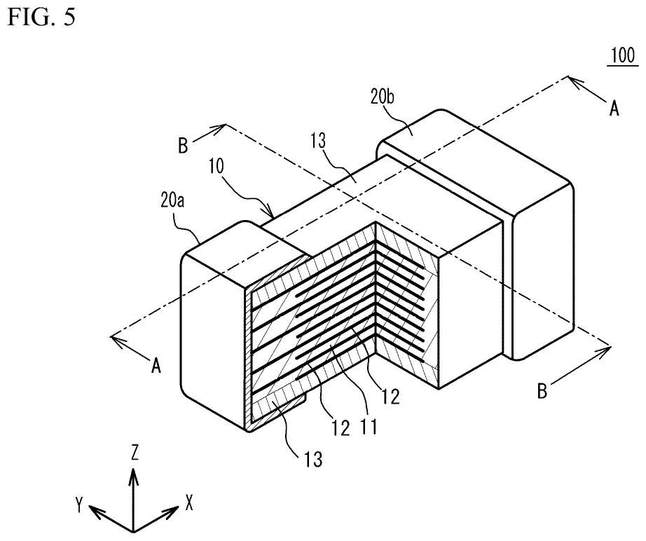

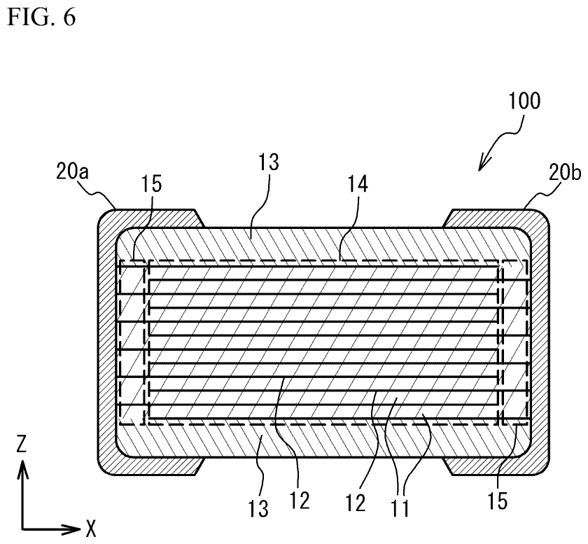

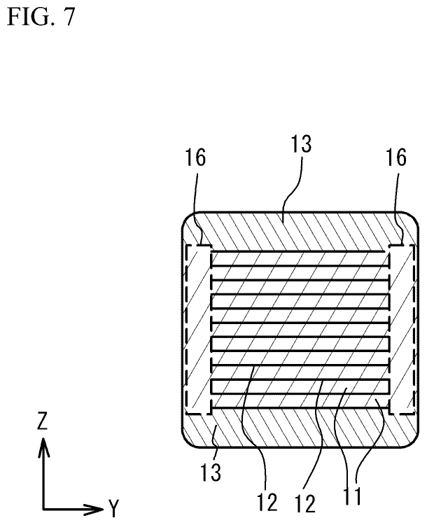

(Second Embodiment) FIG. 5 illustrates a perspective view of a multilayer ceramic capacitor 100 in accordance with a second embodiment, in which a cross section of a part of the multilayer ceramic capacitor 100 is illustrated. FIG. 6 is a cross-sectional view taken along line A-A in FIG. 5. FIG. 7 is a cross-sectional view taken along line B-B in FIG. 5. As illustrated in FIG. 5 to FIG. 7, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 5 to FIG. 7, a Z-axis direction (first direction) is the stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The multilayer chip 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. As long as the internal electrode layers 12 are exposed on two different surfaces and are electrically connected to different external electrodes, the configurations are not limited to those illustrated in FIG. 5 to FIG. 7.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. It is preferable that the average thickness per layer of the internal electrode layer 12 in the Z-axis direction is, for example, 5.0 μm or less, 3.0 μm or less, or 1.0 μm or less. The thickness of the internal electrode layer 12 is determined by observing the cross section of the multilayer ceramic capacitor 100 with a SEM (scanning electron microscope), measuring the thickness at 10 points for each of the 10 different internal electrode layers 12, and calculating the average value of all the measurement points.

The dielectric layer 11 is the dielectric ceramic composition according to the first embodiment. The thickness of the dielectric layer 11 is, for example, 5.0 μm or less, 3.0 μm or less, or 1.0 μm or less. The thickness of the dielectric layer 11 is determined by observing the cross section of the multilayer ceramic capacitor 100 with a SEM (scanning electron microscope), measuring the thickness of each of the 10 different dielectric layers 11 at 10 points, and calculating the average value of all measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), or ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 6, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 7, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

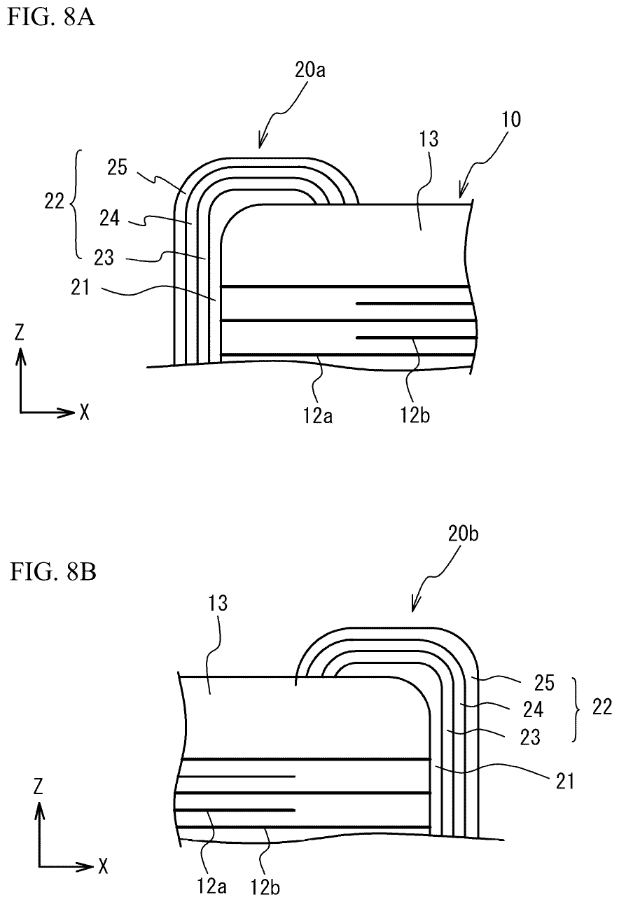

FIG. 8A is an enlarged cross-sectional view of the vicinity of the external electrode 20a. FIG. 8B is an enlarged cross-sectional view of the vicinity of the external electrode 20b. In FIG. 8A and FIG. 8B, hatches are omitted. As illustrated in FIG. 8A and FIG. 8B, the external electrodes 20a and 20b have a structure in which a plated layer 22 is provided on a base layer 21. The base layer 21 is mainly composed of nickel, copper, or the like. The base layer 21 may contain a ceramic grain as a co-material, or may contain a glass component. The plated layer 22 is mainly composed of a metal such as nickel, copper, aluminum, zinc, tin, or the like, or an alloy of two or more of these metals. The plated layer 22 may be a plated layer of a single metal component, or may be a plurality of plating layers of different metal components. For example, the plated layer 22 has a structure in which a first plated layer 23, a second plated layer 24, and a third plated layer 25 are formed in this order from the base layer 21 side. The first plated layer 23 is, for example, a copper-plated layer. The second plated layer 24 is, for example, a nickel-plated layer. The third plated layer 25 is, for example, a tin-plated layer.

In the multilayer ceramic capacitor 100, since the dielectric layer 11 has the dielectric ceramic composition according to the first embodiment, it is possible to improve the bias characteristics while maintaining the ferroelectricity.

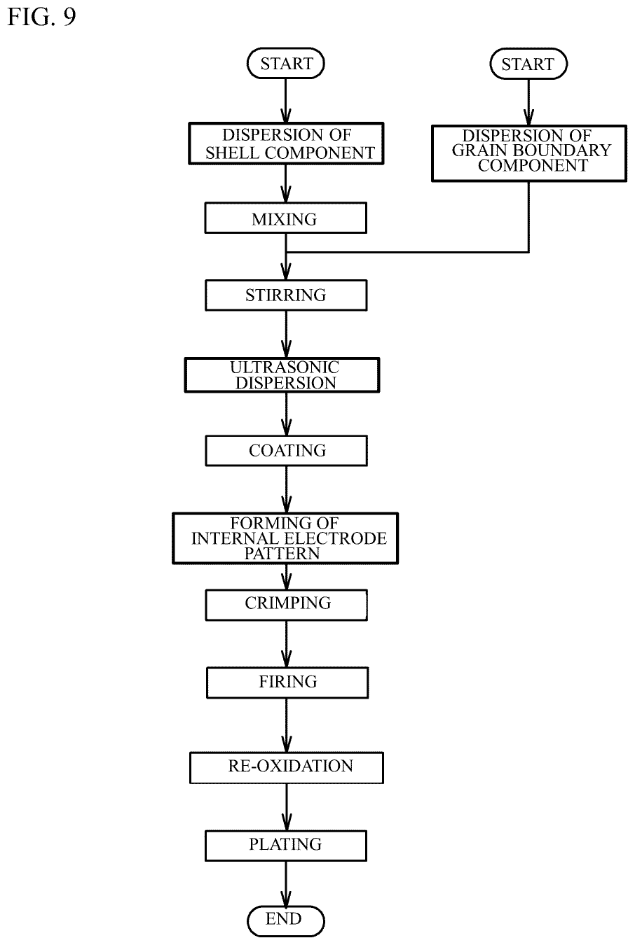

Next, a description will be given of a manufacturing method of the multilayer ceramic capacitors 100. FIG. 9 illustrates a manufacturing method of the multilayer ceramic capacitor 100.

(Dispersion process of shell components) The shell components to be added to the shell portion 32 are dispersed in zirconia beads and ethanol. The shell components are materials containing calcium, such as CaCO₃. Furthermore, the shell components may contain rare earth elements such as HO₂O₃. The liquid from which the zirconia beads are separated after dispersion is called Liquid A.

(Dispersion process of grain boundary components) Next, the grain boundary components are dispersed in zirconia beads and ethanol. The grain boundary components are materials containing silicon, such as SiO₂. Furthermore, the grain boundary components may contain MnCO₃, MgO, Al₂O₃, or the like. The liquid from which the zirconia beads are separated after dispersion is called Liquid B.

(Mixing process) Next, barium titanate powder is mixed with Liquid A, and toluene and a dispersant are added to disperse the mixture with zirconia beads. For example, barium titanate is dispersed until the D50% particle diameter of the particle size distribution becomes the primary diameter. The liquid from which the zirconia beads are separated after dispersion is called liquid C.

(Stirring process) Liquids B and C are combined in a tank and stirred and mixed with a propeller.

(Ultrasonic dispersion process) Next, an organic binder such as polyvinyl butyral (PVB) is mixed with the liquid obtained in the stirring process, and ultrasonic waves are applied to make an organic slurry.

(Coating process) Next, the obtained organic slurry is used to coat a ceramic green sheet 51 on a substrate by, for example, a die coater method or a doctor blade method, and then dried. The substrate is, for example, a polyethylene terephthalate (PET) film. Figures illustrating the coating process are omitted.

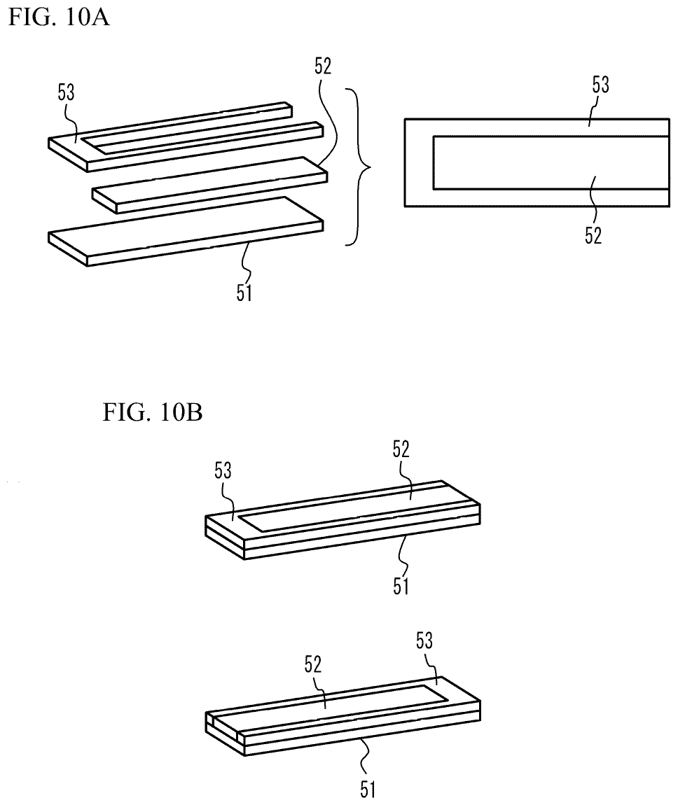

(Forming of internal electrode pattern) Next, as illustrated in FIG. 10A, a metal conductive paste containing an organic binder for forming internal electrodes is printed on the surface of the ceramic green sheet 51 by screen printing, gravure printing, or the like. Internal electrode patterns 52 are arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium calcium titanate having an average particle size of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 10A, on the ceramic green sheet 51, a dielectric pattern 53 is arranged by printing a dielectric pattern paste in the peripheral area where the internal electrode pattern 52 is not printed, and a gap with the internal electrode pattern 52 is filled. The ceramic green sheet 51 on which the internal electrode pattern 52 and the dielectric pattern 53 are printed is referred to as a stack unit.

Thereafter, as illustrated in FIG. 10B, the internal electrode layers 12 and the dielectric layers 11 are arranged alternately, and the internal electrode layers 12 have edges on both longitudinal end surfaces of the dielectric layers 11. The stack units are stacked so that they are alternately exposed and drawn out alternately to a pair of the external electrodes 20a and 20b having different polarities. For example, the number of stacked layers of the internal electrode pattern 52 is set to 100 to 1000 layers.

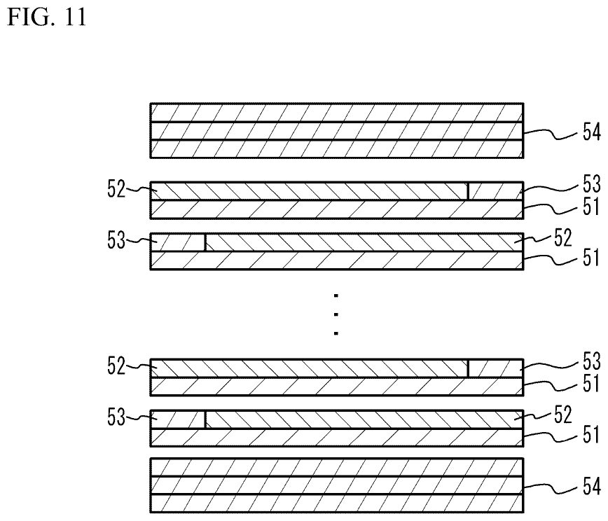

(Crimping Process) As illustrated in FIG. 11, a predetermined number (for example, 2 to 10 layers) of cover sheets 54 are stacked on top and bottom of the multilayer body in which the stack units are stacked and bonded by thermocompression. As an example of the ceramic material for the cover sheet 54, the dielectric ceramic composition described above can be used. Thereafter, the multilayer body is cut into a predetermined chip size (for example, 1.0 mm×0.5 mm).

(Firing process) After de-binding the ceramic multilayer body thus obtained in an N₂ atmosphere, air atmosphere or the like, a metal paste that will become the base layer of the external electrodes 20a and 20b is applied by a dip method, and the ceramic multilayer body held in a reductive atmosphere under an oxygen partial pressure of 10⁻¹⁰ to 10⁻⁷ atm and is fired at 1100°° C. to 1300° C. for 10 minutes to 2 hours. In this way, the multilayer ceramic capacitor 100 is obtained.

(Re-oxidation treatment process) Thereafter, re-oxidation treatment may be performed at 600° C. to 1000° C. in an N₂ gas atmosphere.

(Plating process) Thereafter, a metal coating such as Cu, Ni, Sn and so on is performed on the base layer of the external electrodes 20a and 20b by plating. Through the above steps, the multilayer ceramic capacitor 100 is completed.

In the manufacturing method according to this embodiment, the dispersion process of the shell component and the dispersion process of the grain boundary component are carried out independently. This prevents the grain boundary component from solid-dissolving in barium titanate during sintering. As a result, the dielectric ceramic composition described in FIG. 1 can be produced.

In addition, the median diameter of barium titanate and the dispersion degree of the shell component (liquid A) can be adjusted independently. This allows the width of the shell portion 32 after sintering to be controlled, and the width of the shell portion 32 of each of the crystal grains 30 can be distributed. For example, the width of the shell portion 32 can be made large in some of the crystal grains 30, and the width of the shell portion 32 can be made small in other crystal grains 30. In this case, the electric field strength required to reverse the polarization of the crystal grains 30 can be distributed, so that the electrostatic capacity falls more gradually with respect to an increase in Bias. Therefore, it becomes possible to design a high relative dielectric constant in a wide electric field region.

Note that in the above embodiments, a multilayer ceramic capacitor has been described as an example of a multilayer ceramic electronic component, but this is not limiting. For example, other multilayer ceramic electronic components such as varistors and thermistors may also be used.

### EXAMPLES

The multilayer ceramic capacitor according to the embodiment was fabricated and its characteristics were investigated.

(Example 1-1) First, the shell components CaCO₃ and HO₂O₃ were weighed out to be 2.06 mol and 0.5 mol, respectively, per 100 mol of BaTiO₃, and dispersed with zirconia beads and ethanol to prepare the liquid A. Similarly, the grain boundary components (SiO₂, MnCO₃, MgO, Al₂O₃) were weighed out to be 1.0 mol, 0.5 mol, 0.5 mol, and 0.5 mol, respectively, per 100 mol of BaTiO₃, and dispersed with zirconia beads and ethanol, and the slurry was separated from the zirconia beads to prepare the liquid B.

Next, BaTiO₃ powder with an average particle size of 150 nm was mixed with the liquid A, toluene, and a dispersant, and dispersed with zirconia beads. Dispersion was stopped when the median diameter of the particle size distribution of BaTiO₃ reached 150 nm. The dispersed slurry was passed through a filter to separate the zirconia beads, and then mixed and stirred in a tank with the previously prepared the liquid C. After that, PVB resin was mixed as a binder and ultrasonic dispersion was performed.

The slurry thus prepared was applied to a PET film using a die coater to form a ceramic green sheet with a thickness of 4.0 μm. After drying, the ceramic green sheet was printed with nickel paste to form an internal electrode pattern. The printed ceramic green sheets were stacked in 11 layers. At this time, the positive electrode patterns and the negative electrode patterns were stacked alternately. Above and below the stacking direction, sheets of the same composition as the ceramic green sheets were stacked up to 400 μm each as cover sheets, and were thermocompression bonded. The plate-shaped molded body thus prepared was cut into individual pieces (chips).

The two opposing faces of the cut chip where the lead-out parts of the internal electrode pattern were exposed were dipped in nickel paste to form terminal electrodes. The chips thus produced were heated to 800° C. at 100° C./h in a reducing atmosphere using N₂—H₂—H₂O mixed gas, and de-bindered. The heating rate was then increased to 6000° C./h, the temperature was raised to 1250° C., and held for 1 minute, then the temperature was lowered to room temperature. The chips thus sintered were then re-oxidized at 800° C. in a dry N₂ atmosphere. In this way, a sample with an external dimension of 1.0 mm×0.5 mm×0.5 mm and a total of 10 effective dielectrics was obtained. The average dielectric thickness of one layer after sintering was 3.0 μm.

(Example 1-2) In Example 1-2, the same amount of Dy₂O₃ was used instead of the shell component HO₂O₃. The other conditions were the same as in Example 1-1.

(Example 1-3) In Example 1-3, the same amount of Gd₂O₃ was used instead of the shell component HO₂O₃. The other conditions were the same as in Example 1-1.

(Example 1-4) In Example 1-4, the same amount of Y₂O₃ was used instead of the shell component HO₂O₃. The other conditions were the same as in Example 1-1.

(Example 1-5) In Example 1-5, both HO₂O₃ and Dy₂O₃ were used instead of the shell component HO₂O₃. The total amount of HO₂O₃ and Dy₂O₃ was the same as in Example 1-1 when HO₂O₃ was used alone, and the mol % of HO₂O₃ and Dy₂O₃ were the same. The other conditions were the same as in Example 1-1.

(Example 1-6) In Example 1-6, both HO₂O₃ and Gd₂O₃ were used instead of the shell component HO₂O₃. The total amount of HO₂O₃ and Gd₂O₃ was the same as in Example 1-1, when HO₂O₃ was used alone, and the mol % of HO₂O₃ and Gd₂O₃ were the same. The other conditions were the same as in Example 1-1.

(Comparative Example 1-1) The materials and compounding ratios used for the ceramic green sheets were the same as in Example 1-1, but all the raw materials were dispersed together with zirconia beads, a solvent, and a dispersant, and a binder was added to create an organic slurry. In addition, a standard heating rate of 300° C./h was used for firing after the binder was removed. The other conditions were the same as in Example 1-1.

(Comparative Example 1-2) In Comparative Example 1-2, the same amount of Tb₂O₃ was used instead of the shell component HO₂O₃. The other conditions were the same as in Example 1-1.

(Comparative Example 1-3) In Comparative Example 1-3, the shell component Ho₂O₃ was replaced with the same amount of Yb₂O₃. The other conditions were the same as in Example 1-1.

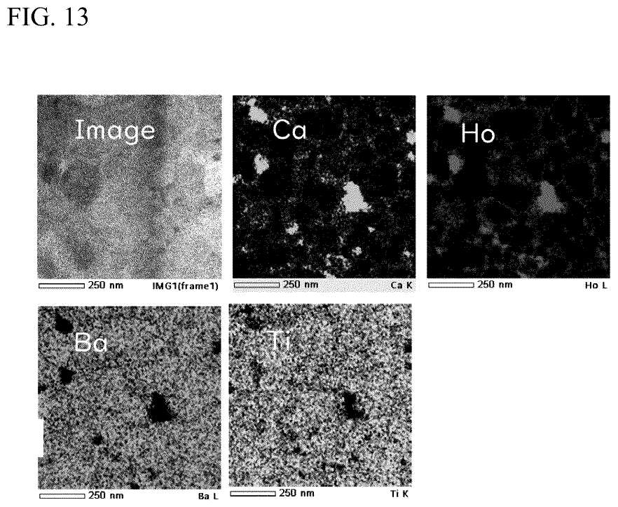

The cross sections of the fired samples of Examples 1-1 to 1-6 and Comparative Examples 1-1 to 1-3 were analyzed using a transmission electron microscope (TEM) equipped with an Energy Dispersive X-ray Spectroscopy (EDX) detector. FIG. 12 illustrates the element map of Example 1-1, and FIG. 13 illustrates the element map of Comparative Example 1-1. It can be seen that in Example 1-1, the BaTiO₃ grains form a core-shell structure in which the outer periphery is covered with a shell of calcium and holmium, leaving a core of BaTiO₃ in the center. When the calcium amount in the core portion and the shell portion was quantitatively analyzed by EDX, the calcium amount in the core portion was not detected at all or was extremely small near the detection limit, while the calcium concentration in the shell portion with respect to the titanium in the parent phase was 2.0 mol % or more, and it was confirmed that the calcium concentration difference between the core portion and the shell portion was at least 100 times. On the other hand, looking at the element map of Comparative Example 1-1, it can be seen that calcium and holmium were segregated as a phase different from BaTiO₃, and a core-shell structure could not be formed.

The electrostatic capacity was obtained from these samples using an LCR meter under conditions of 10 V/μm DC voltage, 1 kHz, and 0.5 Vrms. The relative dielectric constant of the dielectric layer was calculated from the effective area of the internal electrode layers, number of layers, dielectric thickness, and vacuum dielectric constant. As a result, the relative dielectric constants under 10 V/μm application for Example 1-1 and Comparative Example 1-1 were 800 and 630, respectively. From this result, it was confirmed that Example 1-1 realized superior bias characteristics compared to Comparative Example 1-1. The mechanism of the improvement of bias characteristics by the shell portion in which calcium is solid-dissolved has not yet been fully identified, but it is believed that the introduction of a distribution in the electric field (coercive field) required for polarization reversal by the solid solution of calcium caused a change in the voltage dependency of the polarization reversal response to the external voltage (the coefficient of response is the dielectric constant). In addition, it is possible that the solid solution of calcium causes the crystal lattice to shrink, which applies stress to the BaTiO₃ core, and this stress affects the stability of the ferroelectric domain. Since these two are independent in principle, they probably act simultaneously.

In Examples 1-2 to 1-6, a shell portion in which calcium is solid-dissolved was formed, and the relative dielectric constant was comparable to that of holmium alone. As a result, Example 1-1, which used holmium alone, showed the best characteristics. On the other hand, when the rare earth was replaced with terbium (Comparative Example 1-2) and ytterbium (Comparative Example 1-3), a shell portion in which calcium was solid-dissolved was not formed, and calcium segregated as in Comparative Example 1-1, despite being produced by the same process as in Examples 1-1 to 1-6. The relative dielectric constant under application of 10 V/μm was also worse than that of Comparative Example 1-1. From this, it is determined that terbium and ytterbium are unsuitable as shell components.

(Example 2) In Example 2, the starting particle size of BaTiO₃ in Example 1-1, 150 nm, was replaced with 250 nm. The grain boundary components were made of three types, SiO₂, MgO, and Al₂O₃, without using MnCO₃. The other conditions were the same as in Example 1-1.

(Comparative Example 2) In Comparative Example 2, the starting particle size of BaTiO₃ in Comparative Example 1-1, 150 nm, was replaced with 250 nm. The grain boundary components were made of three types, SiO₂, MgO, and Al₂O₃, without using MnCO₃. The other conditions were the same as in Comparative Example 1-1.

The samples in Example 2 and Comparative Example 2 had a relative dielectric constant at 10 V/μm of 750 and 500, respectively. From these results, it was confirmed that in Example 2, the relative dielectric constant under a high electric field can be increased even if the grain size of BaTiO₃ was different. This means that by using the dielectric ceramic composition according to the embodiment, it is possible to design a multilayer ceramic electronic device having a high effective capacity under high voltage. FIG. 14 illustrates an element map by TEM-EDX analysis of Example 2 at this time. Here, in addition to the core-shell elements, grain boundary elements were also added and analyzed. Although the grain size was different, a core-shell structure having a shell portion in which calcium and holmium were solid-dissolved was confirmed as in Example 1-1. It was confirmed that the calcium concentration in the shell portion was 10 times or more that of the core portion. In addition, it was confirmed that grain boundaries in which magnesium, aluminum, and silicon were localized were formed. In this way, by designing the grain boundaries to wet and spread uniformly, the shell components (calcium and rare earth element) could be distributed to each and every grain, and the shell could be formed uniformly on a macroscopic level.

(Comparative Example 3-1) In Comparative Example 3-1, the starting particle size of BaTiO₃ in Comparative Example 1-1, 150 nm, was replaced with 30 nm. The other conditions were the same as those in Comparative Example 1-1.

(Comparative Example 3-2) In Comparative Example 3-2, the starting particle size of BaTiO₃ in Example 1-1, 150 nm, was replaced with 30 nm. The other conditions were the same as those in Example 1-1.

In both Comparative Examples 3-1 and 3-2, the BaTiO₃ particles grew abnormally during sintering, and the electrical properties were not evaluated (the minimum level of insulation could not be ensured), so the dielectric constant could not be measured. From these results, it was found that it is preferable to set a lower limit for the starting particle size of BaTiO₃.

(Comparative Example 4) In Comparative Example 4, the starting particle size of BaTiO₃ in Comparative Example 1-1, 150 nm, was replaced with 50 nm. The other conditions were the same as those in Comparative Example 1-1.

(Example 4) In Example 4, the starting particle size of BaTiO₃ in Example 1-1, 150 nm, was replaced with 50 nm. The other conditions were the same as those in Example 1-1.

In the samples of Example 4 and Comparative Example 4, the relative dielectric constant at 10 V/μm was 930 and 450, respectively. From these results, it was confirmed that the relative dielectric constant in a high electric field can be increased in Example 4.

(Comparative Example 5) In Comparative Example 5, the starting particle size of BaTiO₃ in Comparative Example 1-1, 150 nm, was replaced with 100 nm. The other conditions were the same as those in Comparative Example 1-1.

(Example 5) In Example 5, the starting particle size of BaTiO₃ in Example 1-1, 150 nm, was replaced with 100 nm. The other conditions were the same as those in Example 1-1.

The samples of Example 5 and Comparative Example 5 had a relative dielectric constant of 880 and 480 at 10 V/μm, respectively. From these results, it was confirmed that Example 5 can increase the relative dielectric constant under a high electric field.

(Comparative Example 6) In Comparative Example 6, the starting particle size of BaTiO₃ in Comparative Example 1-1 was replaced with 400 nm instead of 150 nm. The other conditions were the same as those in Comparative Example 1-1.

(Example 6) In Example 6, the starting particle size of BaTiO₃ in Example 1-1 was replaced with 400 nm instead of 150 nm. The other conditions were the same as those in Example 1-1.

The samples of Example 6 and Comparative Example 6 had a relative dielectric constant of 700 and 350 at 10 V/μm, respectively. From these results, it was confirmed that Example 6 can increase the relative dielectric constant under a high electric field.

(Comparative Example 7-1) In Comparative Example 7-1, the starting particle size of BaTiO₃ in Comparative Example 1-1, 150 nm, was replaced with 500 nm. The other conditions were the same as in Comparative Example 1-1.

(Comparative Example 7-2) In Comparative Example 7-2, the starting particle size of BaTiO₃ in Example 1-1, 150 nm, was replaced with 500 nm. The other conditions were the same as in Example 1-1.

In both Comparative Examples 7-1 and 7-2, the electrical properties could not be evaluated because the material did not become sufficiently dense even when the firing temperature was raised to 1300° C. From these results, it was found that it is preferable to set an upper limit on the starting particle size of BaTiO₃.

The above results are shown in Table 1.

TABLE 1

| | | STARTING | SOLID | | RELATIVE |
|---|---|---|---|---|---|
| | | PARTICLE | SOLUTION | RARE | DIELECTRIC |
| | | SIZE | or | EARTH | CONSTANT |
| | DISPERSION | (nm) | SEGREGATION | ELEMENT | @10 V/μm |
| EXAMPLE 1-1 | INDIVIDUAL | 150 | SOLID | Ho | 800 |
| | | | SOLUTION | | |
| EXAMPLE 1-2 | INDIVIDUAL | 150 | SOLID | Dy | 740 |
| | | | SOLUTION | | |
| EXAMPLE 1-3 | INDIVIDUAL | 150 | SOLID | Gd | 710 |
| | | | SOLUTION | | |
| EXAMPLE 1-4 | INDIVIDUAL | 150 | SOLID | Y | 780 |
| | | | SOLUTION | | |
| EXAMPLE 1-5 | INDIVIDUAL | 150 | SOLID | Ho & Dy | 760 |
| | | | SOLUTION | | |
| EXAMPLE 1-6 | INDIVIDUAL | 150 | SOLID | Ho & Gd | 780 |
| | | | SOLUTION | | |
| COMPARATIVE | TOGETHER | 150 | SEGREGATION | Ho | 630 |
| EXAMPLE 1-1 | | | | | |
| COMPARATIVE | INDIVIDUAL | 150 | SEGREGATION | Tb | 420 |
| EXAMPLE 1-2 | | | | | |
| COMPARATIVE | INDIVIDUAL | 150 | SEGREGATION | Tb | 510 |
| EXAMPLE 1-3 | | | | | |
| EXAMPLE 2 | INDIVIDUAL | 250 | SOLID | Ho | 500 |
| | | | SOLUTION | | |
| COMPARATIVE | TOGETHER | 250 | SEGREGATION | Ho | 750 |
| EXAMPLE 2 | | | | | |
| COMPARATIVE | INDIVIDUAL | 30 | ABNORMAL | Ho | — |
| EXAMPLE 3-1 | | | GROWTH | | |
| COMPARATIVE | TOGETHER | 30 | ABNORMAL | Ho | — |
| EXAMPLE 3-2 | | | GROWTH | | |
| COMPARATIVE | TOGETHER | 50 | SEGREGATION | Ho | 450 |
| EXAMPLE 4 | | | | | |
| EXAMPLE 4 | INDIVIDUAL | 50 | SOLID | Ho | 930 |
| | | | SOLUTION | | |
| COMPARATIVE | TOGETHER | 100 | SEGREGATION | Ho | 480 |
| EXAMPLE 5 | | | | | |
| EXAMPLE 5 | INDIVIDUAL | 100 | SOLID | Ho | 880 |
| | | | SOLUTION | | |
| COMPARATIVE | TOGETHER | 400 | SEGREGATION | Ho | 350 |
| EXAMPLE 6 | | | | | |
| EXAMPLE 6 | INDIVIDUAL | 400 | SOLID | Ho | 700 |
| | | | SOLUTION | | |
| COMPARATIVE | TOGETHER | 500 | NOT | Ho | — |
| EXAMPLE 7-1 | | | DENSIFIED | | |
| COMPARATIVE | INDIVIDUAL | 500 | NOT | Ho | — |
| EXAMPLE 7-2 | | | DENSIFIED | | |

(Example 8-1) In Example 8-1, the grain boundary component was one type, SiO₂. The other conditions were the same as in Example 1-1.

(Example 8-2) In Example 8-2, the grain boundary components were two types, SiO₂ and Al₂O₃. The other conditions were the same as in Example 1-1.

(Example 8-3) In Example 8-3, the grain boundary components were two types, SiO₂ and MgO. The other conditions were the same as in Example 1-1.

(Example 8-4) In Example 8-4, the grain boundary components were two types: SiO₂ and MnCO₃. The other conditions were the same as in Example 1-1.

The average life (h@150° C., 50V/μm) was measured for the samples of Comparative Example 1-1, Example 1-1, and Examples 8-1 to 8-4. The average life was measured as the average time until a short circuit failure occurred under the conditions of 150° C. and 50V/μm.

The results are shown in Table 2. Table 2 also shows the results of Example 1-1 and Comparative Example 1-1. In all of Examples 8-1 to 8-4, a shell portion in which calcium was solid-dissolved was formed, and the calcium concentration in the shell portion was 10 times or more that in the core portion. In all of Examples 8-1 to 8-4, the bias characteristics (dielectric constant under a high electric field) were good. The average life was better in Examples 8-2 to 8-4 and Example 1-1 than in Example 8-1. From these results, it was found that it is preferable to use two or more types of grain boundary components. Furthermore, since Example 1-1 was better than Examples 8-2 to 8-4, it was found that it is preferable to use three or more types of grain boundary components.

TABLE 2

| | | STARTING | SOLID | | RELATIVE | | AVERAGE |
|---|---|---|---|---|---|---|---|
| | | PARTICLE | SOLUTION | RARE | DIELECTRIC | GRAIN | LIFE (h) |
| | DIS- | SIZE | or SEG- | EARTH | CONSTANT | BOUNDARY | @150° C., |
| | PERSION | (nm) | REGATION | ELEMENT | @10 V/μm | COMPONENT | 50 V/μm |
| COM- | TO- | 150 | SEG- | Ho | 630 | Si, Al, Mg, Mn | 200 |
| PARATIVE | GETHER | | REGATION | | | | |
| EXAMPLE | | | | | | | |
| 1-1 | | | | | | | |
| EXAMPLE | INDI- | 150 | SOLID | Ho | 800 | Si, Al, Mg, Mn | 290 |
| 1-1 | VIDUAL | | SOLUTION | | | | |
| EXAMPLE | INDI- | 150 | SOLID | Ho | 880 | Si | 160 |
| 8-1 | VIDUAL | | SOLUTION | | | | |
| EXAMPLE | INDI- | 150 | SOLID | Ho | 790 | Si, Al | 180 |
| 8-2 | VIDUAL | | SOLUTION | | | | |
| EXAMPLE | INDI- | 150 | SOUD | Ho | 830 | Si, Mg | 220 |
| 8-3 | VIDUAL | | SOLUTION | | | | |
| EXAMPLE | INDI- | 150 | SOLID | Ho | 770 | Si, Mn | 250 |
| 8-4 | VIDUAL | | SOLUTION | | | | |

(Example 9-1) In Example 9-1, part of the calcium in the shell portion was replaced with strontium. In the shell, the ratio of strontium to the sum of strontium and calcium (Sr/(Ca+Sr)) was 0.2. The other conditions were the same as in Example 2.

(Example 9-2) In Example 9-2, part of the calcium in the shell portion was replaced with strontium. In the shell portion, the ratio of strontium to the sum of strontium and calcium (Sr/(Ca+Sr)) was 0.4. The other conditions were the same as in Example 2.

(Example 9-3) In Example 9-3, part of the calcium in the shell portion was replaced with strontium. In the shell, the ratio of strontium to the sum of strontium and calcium (Sr/(Ca+Sr)) was 0.6. The other conditions were the same as in Example 2.

(Example 9-4) In Example 9-4, part of the calcium in the shell portion was replaced with strontium. In the shell, the ratio of strontium to the sum of strontium and calcium (Sr/(Ca+Sr)) was 0.8. The other conditions were the same as in Example 2.

The results are shown in Table 3. We also investigated whether the capacity-temperature characteristic satisfied X7T. From the results in Table 3, it was found that the larger Sr/(Ca+Sr) was, the larger the relative dielectric constant at 10V/μm was. On the other hand, if Sr/(Ca+Sr) was large, it may not necessarily satisfy the EIA standard X7T, so it is preferable that Sr/(Ca+Sr) is 0.4 or less.

TABLE 3

| | | | STARTING | SOLID | | RELATIVE | | TEMP- |
|---|---|---|---|---|---|---|---|---|
| | | | PARTICLE | SOLUTION | RARE | DIELECTRIC | GRAIN | ERATURE |
| | DIS- | Sr/ | SIZE | of SEG- | EARTH | CONSTANT | BOUNDARY | CHARAC- |
| | PERSION | (Ca + Sr) | (nm) | REGATION | ELEMENT | @10 V/μm | COMPONENT | TERISTIC |
| COM- | TO- | 0.0 | 250 | SEG- | Ho | 500 | Si, Al, Mg | GOOD |
| PARATIVE | GETHER | | | REGATION | | | | |
| EXAMPLE 2 | | | | | | | | |
| EXAMPLE 2 | INDI- | 0.0 | 250 | SOLID | Ho | 750 | Si, Al, Mg | GOOD |
| | VIDUAL | | | SOLUTION | | | | |
| EXAMPLE | INDI- | 0.2 | 250 | SOLID | Ho | 880 | Si, Al, Mg | GOOD |
| 9-1 | VIDUAL | | | SOLUTION | | | | |
| EXAMPLE | INDI- | 0.4 | 250 | SOLID | Ho | 790 | Si, Al, Mg | GOOD |
| 9-2 | VIDUAL | | | SOLUTION | | | | |
| EXAMPLE | INDI- | 0.8 | 250 | SOLID | Ho | 830 | Si, Al, Mg | BAD |
| 9-3 | VIDUAL | | | SOLUTION | | | | |
| EXAMPLE | INDI- | 0.8 | 250 | SOLID | Ho | 770 | Si, Al, Mg | BAD |
| 9-4 | VIDUAL | | | SOLUTION | | | | |

Although the embodiments of the present invention have been described in detail, it is to be understood that the various change, substitutions, and alterations could be made hereto without departing from the spirit and scope of the invention.

What is claimed is:

1. A multilayer ceramic electronic device comprising:
a dielectric layer that contains a plurality of crystal grains, each of which has a core portion and a shell portion surrounding the core portion, a main component of the core portion and the shell portion being barium titanate, calcium being solid-dissolved in the shell portion, a concentration of calcium of the shell portion being 10 times or more than a concentration of calcium of the core portion;
internal electrodes that sandwich the dielectric layer and contain nickel or copper as a main component; and
an external electrode that is electrically connected to one of the internal electrodes.

2. The multilayer ceramic electronic device as claimed in claim 1, wherein the shell portion contains at least one of gadolinium, dysprosium, holmium or yttrium.

3. The multilayer ceramic electronic device as claimed in claim 1, wherein at least one of silicon, aluminum, magnesium, or manganese is present at a grain boundary or a grain boundary triple point between the plurality of crystal grains.

4. The multilayer ceramic electronic device as claimed in claim 1, wherein an average grain diameter of the plurality of crystal grains is 50 nm or more and 400 nm or less.

5. The multilayer ceramic electronic device as claimed in claim 1, wherein the dielectric layer contains a sub crystal grain having a different structure from the plurality of crystal grains.

6. The multilayer ceramic electronic device as claimed in claim 1, wherein the shell portion contains strontium.

7. The multilayer ceramic electronic device as claimed in claim 1,
wherein the shell portion includes strontium, and
wherein a ratio of an amount of strontium with respect to a total amount of strontium and calcium is 0.2 or more and 0.4 or less.

8. A dielectric ceramic composition comprising:
a plurality of crystal grains, each of which has a core portion and a shell portion surrounding the core portion,
wherein a main component of the core portion and the shell portion is barium titanate,
wherein calcium is solid-dissolved in the shell portion, and
wherein a concentration of calcium of the shell portion is 10 times or more than a concentration of calcium of the core portion.
